(19) United States
(12) Patent Application Publication
(10) Pub. No.: US 2017/0311757 A1
(43) Pub. Date: Nov. 2, 2017

(54) DEVICES AND METHODS FOR SUPPORTING AND PREPARING FOODS

(71) Applicants: Alan BACKUS, Los Angeles, CA (US); Marici IULIUS, Las Vegas, NV (US)

(72) Inventors: Alan BACKUS, Los Angeles, CA (US); Marici IULIUS, Las Vegas, NV (US)

(21) Appl. No.: 15/142,072

(22) Filed: Apr. 29, 2016

(51) Int. Cl. A47J 37/12

(52) U.S. Cl. CPC A47J 37/129; A47J 37/128; A47J 37/1271; A47J 37/1266; A47J 37/1261; A47J 37/1223; A23V 2002/00

(57) ABSTRACT

Food holding, mounting, and/or positioning devices, with particular application to, although not necessarily limited to, supporting unitary articles of food, including, but not necessarily limited to, deep frying large fowl, including Thanksgiving Day sized turkeys. A simplified cooking liquid filtering apparatus. A method and apparatus to simplifies, and makes more accurate, cooking liquid dispensing, and measurement. Example devices use liquid to cook foods, with particular application to, but not limited to, deep frying large unitary food articles, including, but not limited to, large fowl, including Thanksgiving Day sized turkeys. Further example devices store, dispense, and measure pourable materials, including both liquid and dry materials. An informational device, with particular applications to, but not limited to, provides instructions, and more particularly, although not limited to, providing operating instructions for household cooking devices.

### TECHNICAL FIELD

The present application relates to devices which facilitate supporting foods while they are being prepared, and which aid in the preparing of foods in general, and more specifically, although not limited to, deep fry unitary foods, and more specifically still, although not limited to, that deep fry fowl.

### BACKGROUND

Deep frying devices for both household and commercial use, are in wide use.

In recent years, devices have become available which cook unitary foods by first immersing a first portion of the unitary foods in hot cooking liquid, and then repositioning the foods and cooking a second, previously uncooked portion.

There is a perception that these recent devices are complicated and difficult to use. Among other things, devices shown herein may favorably alter this negative perception of the complexity of such repositioning process devices.

Also shown herein, are devices to position foods while they are being prepared.

Again shown herein are devices, to cook unitary foods, without repositioning the foods, while still preserving many of the advantages of the repositioning process, including, but not limited to, the conservation of expensive cooking liquids.

Finally, although indoor household turkey fryers have also been around for many years, they are generally fryers that are large enough to cook a Thanksgiving day turkey (herein, as a non-limiting and non-exhaustive example, being around 15 pounds, plus or minus 5 pounds product tag weight), with few or no features to cook such a food utilizing an efficient amount of cooking liquid.

Example embodiments herein have specific features to cook unitary and non-unitary foods in general, and specifically, although not limited to, to cook a Thanksgiving day turkey, while reducing cooking liquid usage.

### BRIEF DESCRIPTION OF THE DRAWINGS

FIG. 1 is a perspective view of an example embodiment showing invertible food support 100.

FIG. 2 is another perspective view of an example embodiment showing invertible food support 100.

FIG. 3 is another perspective view of an example embodiment showing invertible food support 100.

FIG. 4 is a detail enlargement of a portion of FIG. 3, as indicated in FIG. 3.

FIG. 4A is a downward looking plan view, of an example embodiment as indicated in FIG. 4.

FIG. 5 is a perspective of example embodiment 130.

FIG. 6 is a perspective view of an example embodiment of food mount 140.

FIG. 7 is another perspective view of an example embodiment of food mount 140.

FIG. 8 is another perspective view of an example embodiment of food mount 140.

FIG. 9 is an exploded perspective view of an example embodiment of food mount 140

FIG. 10, is a perspective view of an example embodiment utilizing elements of food mount 168.

FIG. 11 is a perspective view of elements of an example embodiment of food mount 168 while they are in use.

FIG. 12 is another perspective view of an example embodiment of food mount 168 during use.

FIG. 13 is a perspective view of elements of an example embodiment of food mount 168 while they are in use.

FIG. 14 is another perspective view of an example embodiment of food mount 168 in use.

FIG. 15 is another perspective view of an example embodiment of food mount 168 while it is in use.

FIG. 16 is a perspective of an example embodiment of food mount 188.

FIG. 17 is a perspective of an example embodiment of food mount 196.

FIG. 18 is a perspective of an example embodiment of food mount 206.

FIG. 19 is another perspective of an example embodiment of food mount 206 while in use.

FIG. 20 is another perspective of an example embodiment of food mount 206 while in use.

FIG. 21 is a perspective view of an example embodiment of food positioning fork 230 in use.

FIG. 23 is another perspective view of an example embodiment of food positioning fork 230 in use.

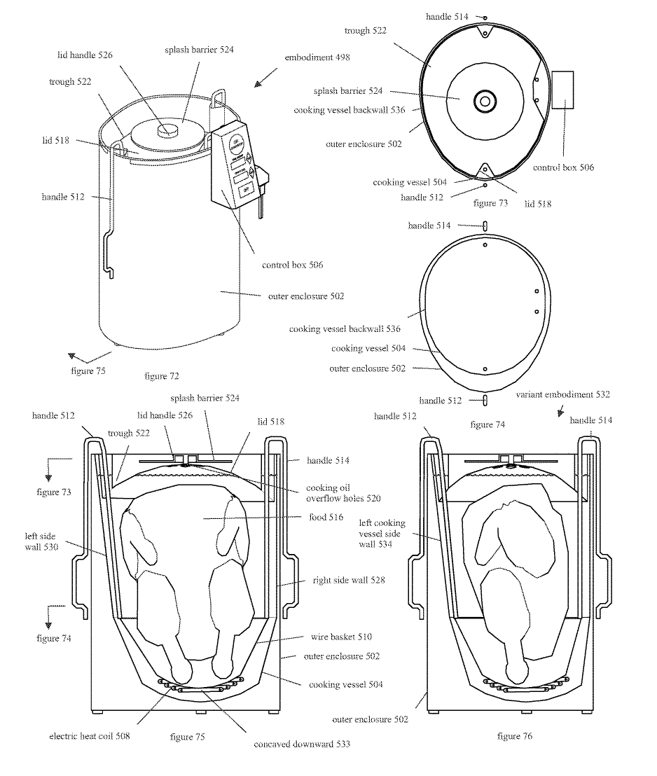

FIG. 22 is a section taken through FIG. 21, as indicated in FIG. 21.

FIG. 22A is an enlarged detail of FIG. 22, as indicated in FIG. 22.

FIG. 24 is an exploded perspective of an example embodiment of food positioning fork 230, in its operating environment.

FIG. 25 is an enlarged perspective of food positioning fork 230.

FIG. 26 is an exploded perspective of fluid filter 244, in its operating environment.

FIG. 27 is a section of an example embodiment of the assembled device shown in FIG. 26, as indicated in FIG. 26.

FIG. 28 is a perspective of an example embodiment of fluid filter 244.

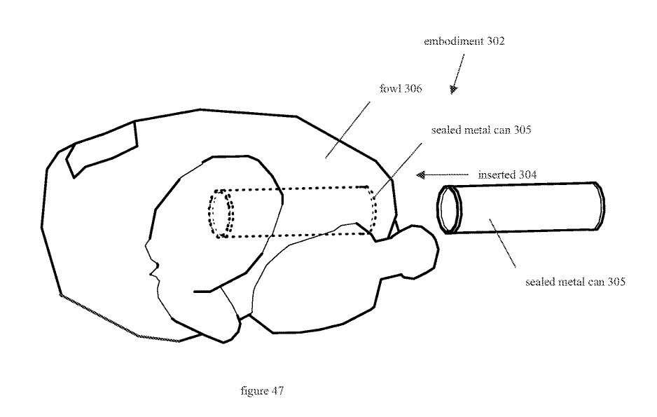

FIG. 29 is a cross section of an example embodiment of the cooking device 176 (a deep fryer as a non-limiting and non-exhaustive example) shown in FIG. 11, as indicated in FIG. 11, utilizing the herein described cooking liquid measurement method.

FIG. 30 is another cross section of an example embodiment of the cooking device 176 (a deep fryer as a non-limiting and non-exhaustive example) shown in FIG. 11, as indicated in FIG. 11, utilizing the described cooking liquid measurement method.

FIG. 31 is yet another cross section of an example embodiment of the cooking device 176 (a deep fryer as a non-limiting and non-exhaustive example) shown in FIG. 11, as indicated in FIG. 11, utilizing the described cooking liquid measurement method.

FIG. 32 is a perspective of example embodiment 268 in use.

FIG. 33 is another perspective of example embodiment 268 in use.

FIG. 34 is another perspective of example embodiment 268 in use.

FIG. 35 is a direct side view of example embodiment 268 in use.

FIG. 36 is another side view of example embodiment 268 in use.

FIG. 37 is another side view of example embodiment 268 in use.

FIG. 38 is another side view of example embodiment 268 in use.

FIG. 39 is a perspective view of an example embodiment of cooking vessel 272, indicating the locations of the section plane views shown in FIGS. 40, 41, 42, and 43.

FIG. 40 is a section view of cooking vessel 272 as indicated in FIG. 39.

FIG. 41 is another section view of cooking vessel 272 as indicated in FIG. 39.

FIG. 42 is another section view of cooking vessel 272 as indicated in FIG. 39.

FIG. 43 is another section view of cooking vessel 272 as indicated in FIG. 39.

FIG. 44 is an exploded perspective view of example embodiment 268.

FIG. 45 is a perspective view of example embodiment 268.

FIG. 46 is a side view of example embodiment 300 in use.

FIG. 47 is a perspective view of example embodiment 302 in use.

FIG. 48 is a perspective view of example embodiment 308 in use.

FIG. 49 is a section through example embodiment 308, as indicated in FIG. 48.

FIG. 50 is another section through example embodiment 308 as indicated in FIG. 48.

FIG. 51 is another section through example embodiment 308 as indicated in FIG. 48.

FIG. 52 is another section through example embodiment 308 as indicated in FIG. 48.

FIG. 53 is an exploded perspective view of example embodiment 308 in use.

FIG. 54 is a perspective view of example embodiment 344.

FIG. 55 is a section through FIG. 54, as indicated in FIG. 54.

FIG. 56 is an exploded perspective an example embodiment showing lid 346 in use.

FIG. 57 is an enlarged detail of FIG. 56, as indicated in FIG. 56.

FIG. 58 is a perspective view of example embodiment 364 in use.

FIG. 59 is a cross-section through FIG. 58, as indicated in FIG. 58.

FIGS. 59A and 59B are cross sections taken from the same viewpoint as FIG. 59, showing variants of example embodiment 364.

FIG. 60 is an exploded perspective view of example embodiment 364.

FIG. 61 is a perspective view of example embodiment 396.

FIG. 62 is an enlarged detail of FIG. 61, as indicated in FIG. 61.

FIG. 63 is a perspective view of example embodiment 396 in use.

FIG. 64 is a perspective of example embodiment 418.

FIG. 65 is an enlarged detail of FIG. 64, as indicated in FIG. 64.

FIG. 66 is a perspective example embodiment 418 in use.

FIG. 67 is a plan view of example embodiment 418.

FIG. 68 is taken from the same viewpoint as FIG. 67, and it shows example embodiment 418 in use, as in FIG. 66.

FIG. 69 is an anterior perspective view of example embodiment 438 in its open position.

FIG. 70 is a posterior perspective view of example embodiment 438 in its open position.

FIG. 71 is an exploded posterior perspective view of example embodiment 438 in its open position.

FIG. 72 is a perspective view of example embodiment 498.

FIG. 73 is a section through example embodiment 498, as indicated in FIG. 75.

FIG. 74 is a section through example embodiment 498, as indicated in FIG. 75.

FIG. 75 is a section through example embodiment 498, as indicated in FIG. 72.

FIG. 76 is a section through example variant embodiment 532, the viewpoint which is analogous to the viewpoint in FIG. 75.

FIG. 77 is an exploded perspective of example embodiment 498.

### DETAILED DESCRIPTION

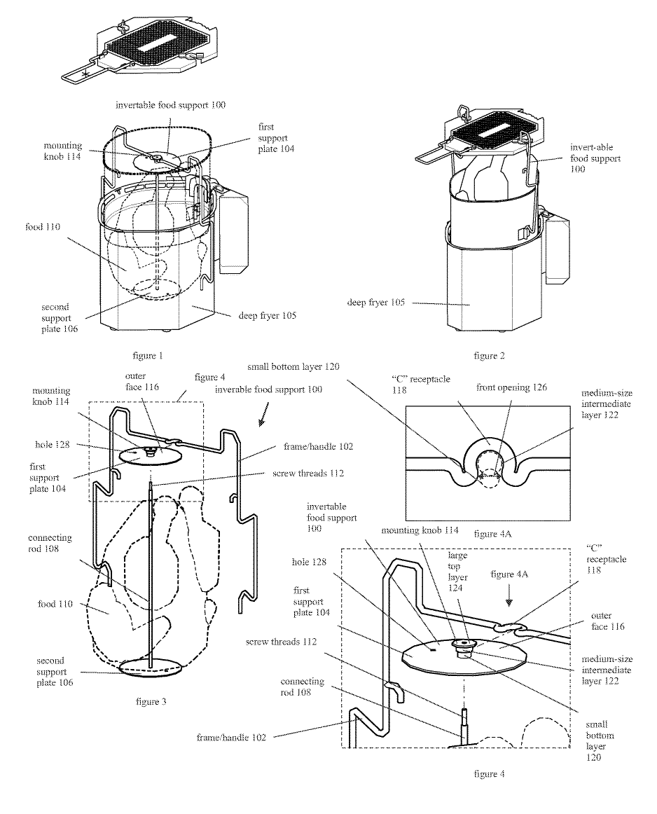

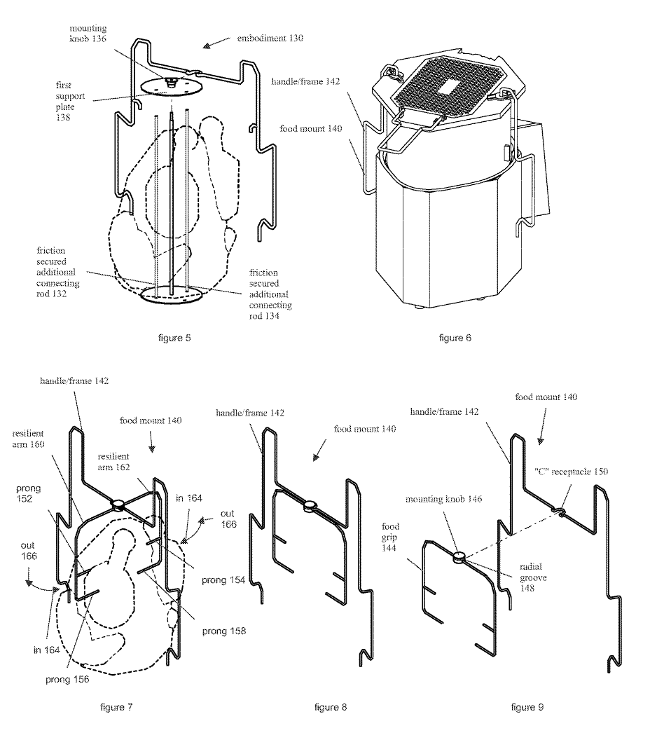

FIGS. 1 through 4 show invertible food support 100:

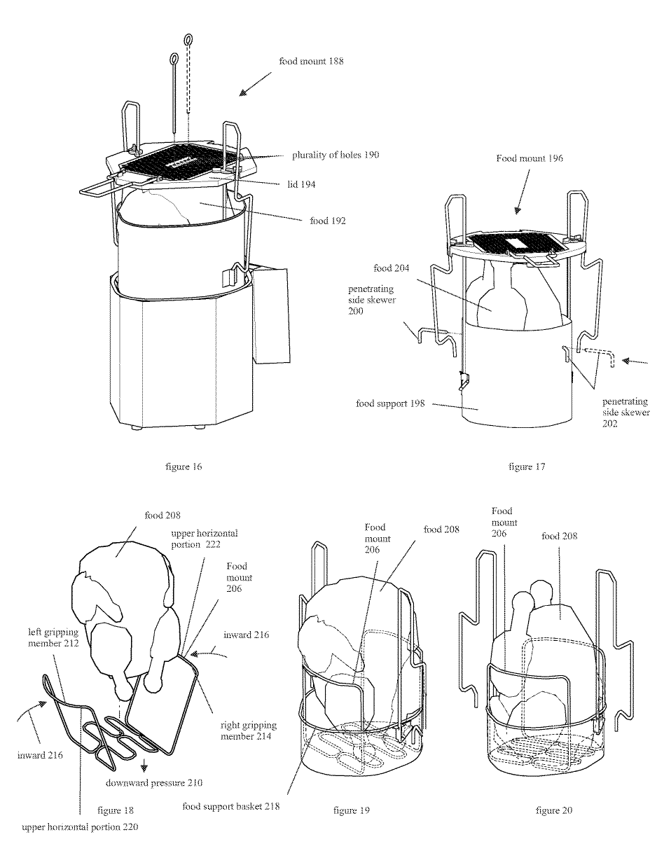

Food support 100 is generally comprised of: frame/handle 102, first support plate 104, second support plate 106, and connecting rod 108 (FIG. 3 in particular).

In general, food 110 (shown as a fowl), is centrally impaled on connecting rod 108 to allow mounting between first support plate 104 and second support plate 106, by screwing first support plate 104 on to screw threads 112, which are located at one end of connecting rod 108.

Mounting knob 114, fixed on to outer face 116 of first support plate 104, is configured to allow connecting rod 108/support plates 104 106/and food 110 combination (herein referred to collectively as the mounting assembly) to be disposed into “C” receptacle 118.

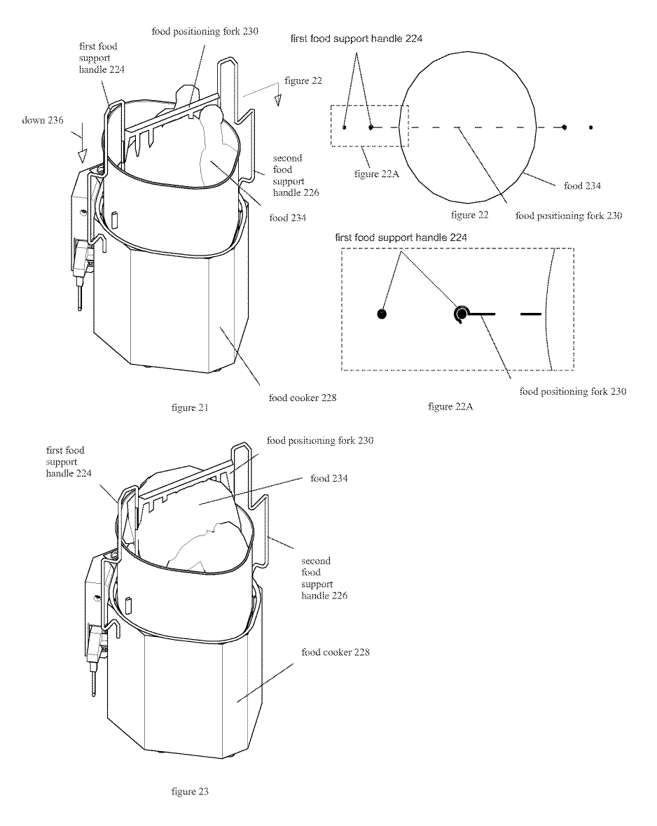

Mounting knob 114 resembles an inverted wedding cake, with small bottom layer 120, medium-size intermediate layer 122, and large top layer 124 (FIG. 4).

Small bottom layer 120 is dimensioned to be tall enough, and small enough in diameter to slide easily into front opening 126 of “C” receptacle 118 (FIG. 4A). Medium-size, intermediate layer 122 is dimensioned to be tall enough and large enough in diameter to fit within the center of “C receptacle 118, but be large enough in diameter so that it cannot exit through front opening 126. Large top layer 124 is dimensioned to prevent mounting knob 114 from dropping through “C” receptacle 118. Large top layer 124 may also serves as a hand grip for the mounting assembly.

Second support plate 106 mirror images first support plate 104. Likewise, screw threads 112 are mirror imaged on the opposite end of connecting rod 108, making connecting rod 108 symmetrical top to bottom.

Connecting rod 108 is square in cross-section. Hole 128 in first support plate 104 is also square, and may be used as a wrench to hold connecting rod 108 in position while second support plate 106 is unscrewed. First support plate 104 and second support plate 106 are analogous, so the above operation can be done vice versa on first support plate 104 and second support plate 106.

In use, one or more articles of food are impaled on connecting rod 108. Second support plate 106, which is attached, prevents such articles from falling off the lower end of connecting rod 108. First support plate 104 is then screwed on to screw threads 112 to connect rod 108. The mounting assembly is then attached to frame/handle 102 by pushing small bottom layer 120 through front opening 126, and allowing medium-size intermediate layer 122 to drop into the interior of “C” receptacle 118, thus securing the attachment and allowing rotation of the mounting assembly, if desired.

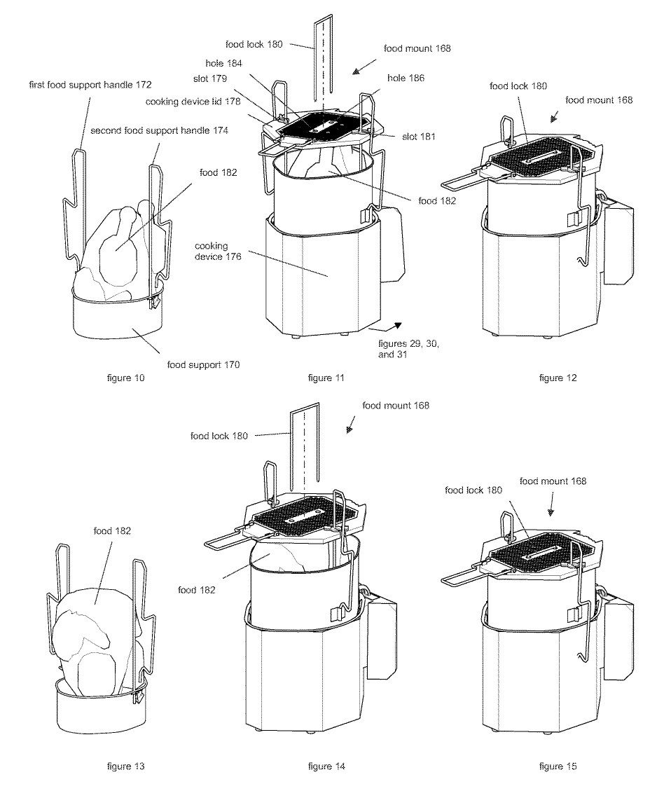

The mounting assembly may then be placed within a cooking environment, by securing frame/handle 102 in place, such as shown in FIG. 1, as a non-limiting and non-exhaustive example, where the mounting assembly is shown being drop into deep fryer 105 (FIGS. 1 and 2). The mounting assembly may be inverted if advantageous, by repeating the above process with second support plate 106 being substituted for first support plate 104. When the mounting assembly is inverted, food naturally slides down connecting rod 108 under gravity onto first support plate 104.

Invertible support 100, with obvious alterations, may be advantageously used in a variety of cooking/food preparation environments, including, as non-limiting and non-exhaustive examples, in bake ovens, convection ovens, food boilers, deep fat fryers, microwaves, radiant heat ovens, freezers, refrigerators, slow cookers, sous vide, etc.

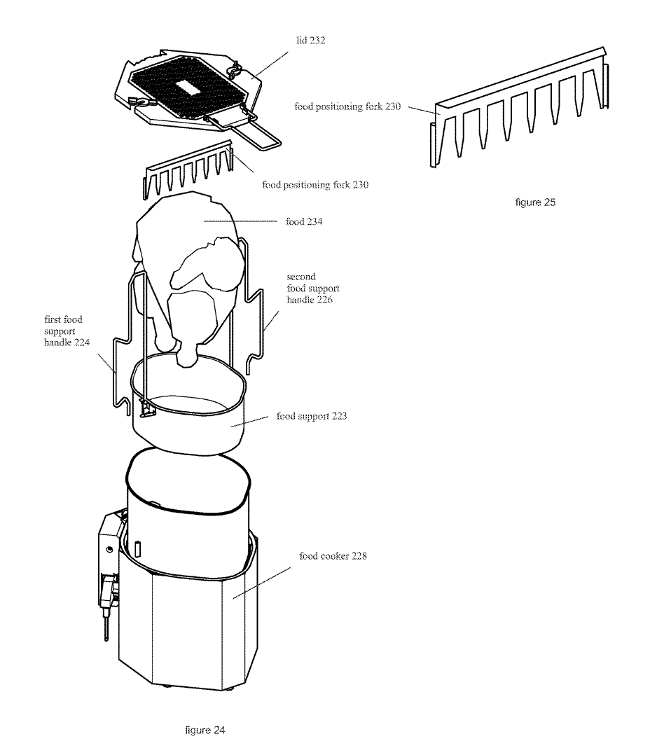

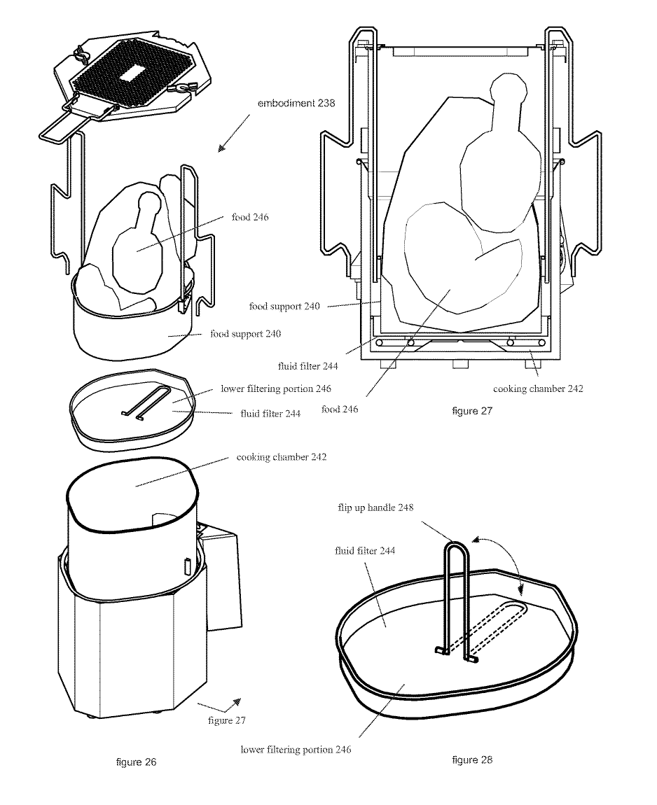

Example embodiment 130, FIG. 5:

FIG. 5, shows example embodiment 130, which shares many features and constructions of invertible food support 100, except it adds friction and compression secured additional connecting rods 132 and 134, which may impale and additionally secure, alone or in concert, food articles mounted on example embodiment 130. Mounting knob 136 is configured to rotate freely relative to first support plate 138, to allow screw attachment to connecting rod 140.

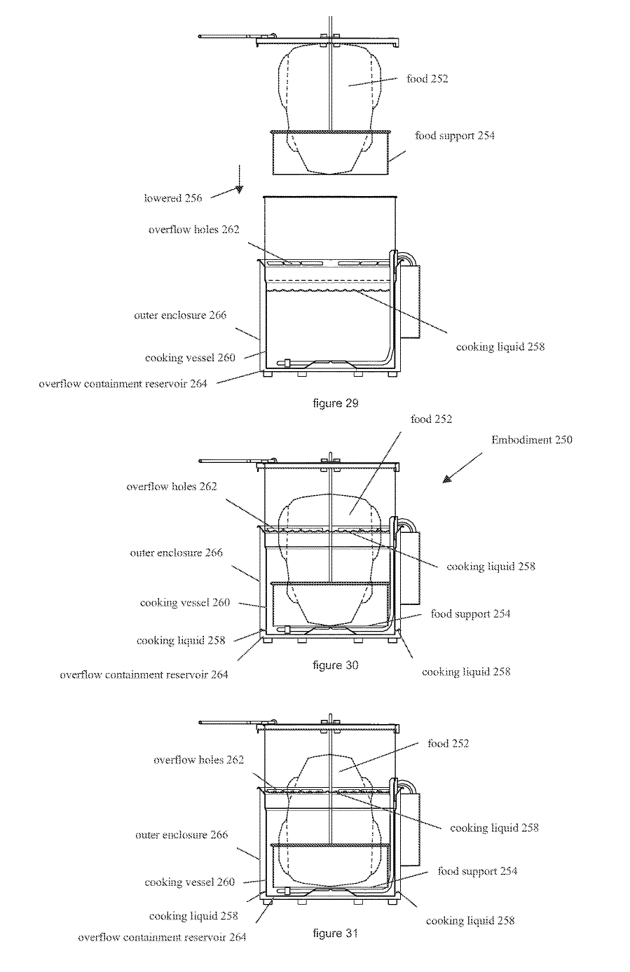

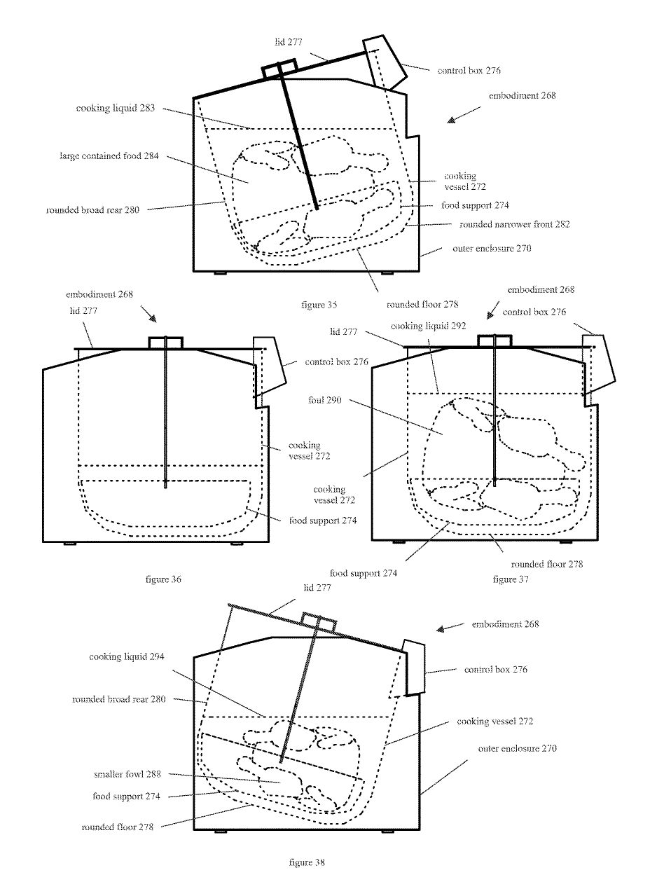

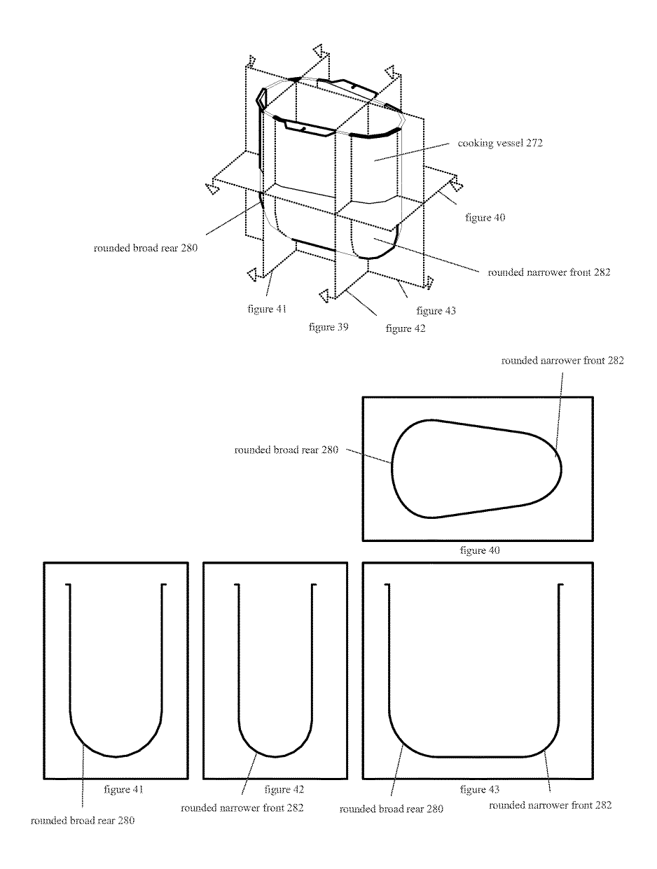

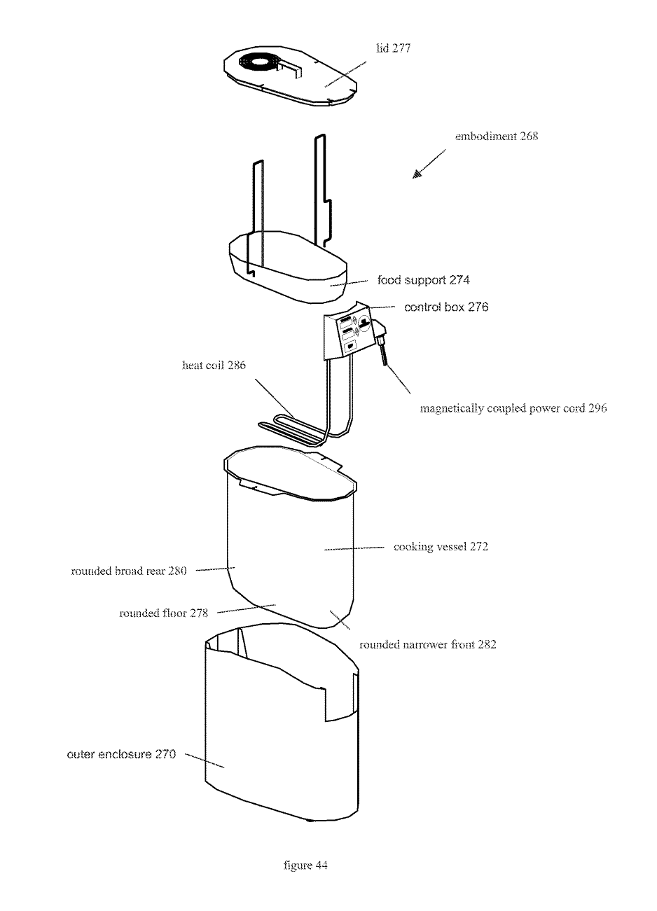

Food mount 140, FIGS. 6 through 9:

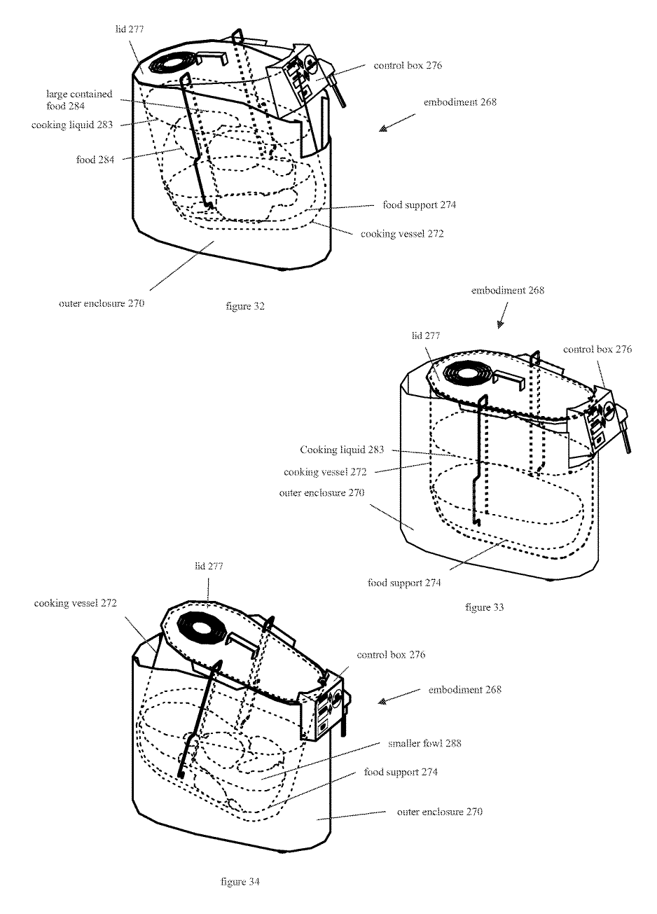

FIGS. 6 through 9 illustrate food mount 140. Here, handle/frame 142, rotatably mounts food grip 144, by “C” receptacle 150 engaging radially grooved mounting knob 146, by snapping within radial groove 148 (FIGS. 7, 8, and 9). Prongs 152, 154, 156, and 158 are mounted on resilient arms 160 and 162, which allow prongs 152, 154, 156, and 158 to resilient move in 164 and out 166, to impale and couple to outer peripheries of food (FIG. 7).

Through limited outward 166 movement, longer prongs 156 and 158 allow food to remain partially impaled while flipping food mount 140 over the food to invert the food.

Once again, food mount 140, with obvious alterations, may be advantageously used in a variety of cooking/food preparation environments, including, as non-limiting and non-exhaustive examples, in bake ovens, convection ovens, food boilers, deep fat fryers, microwaves, radiant heat ovens, freezers, refrigerators, slow cookers, sous vide, etc.

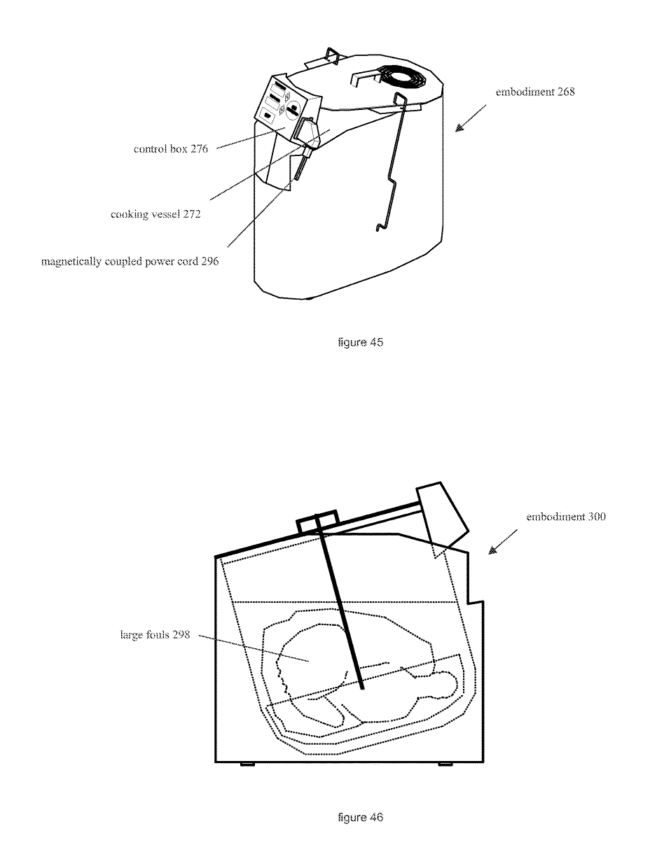

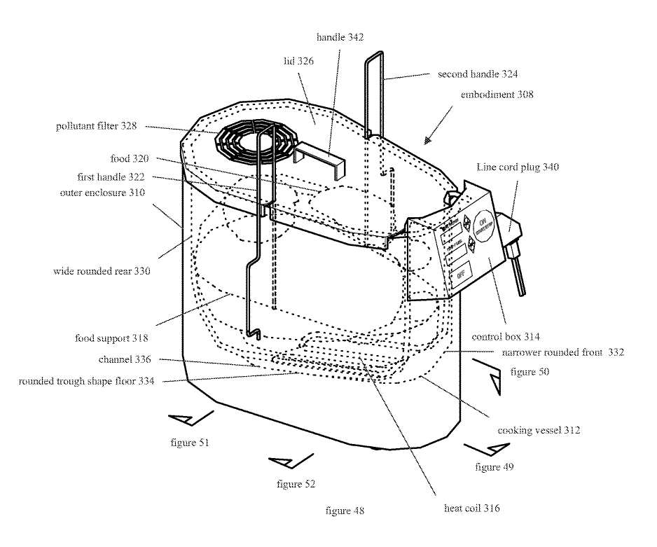

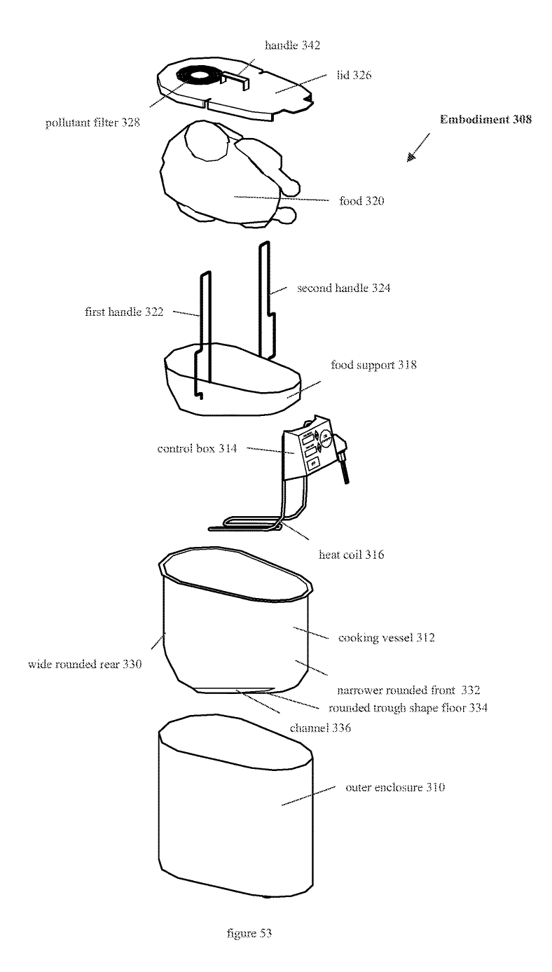

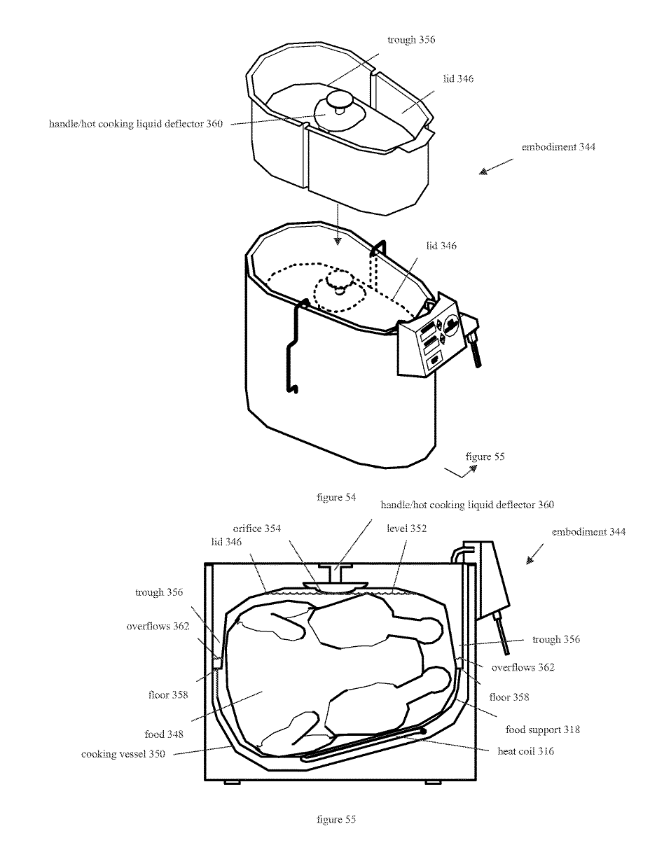

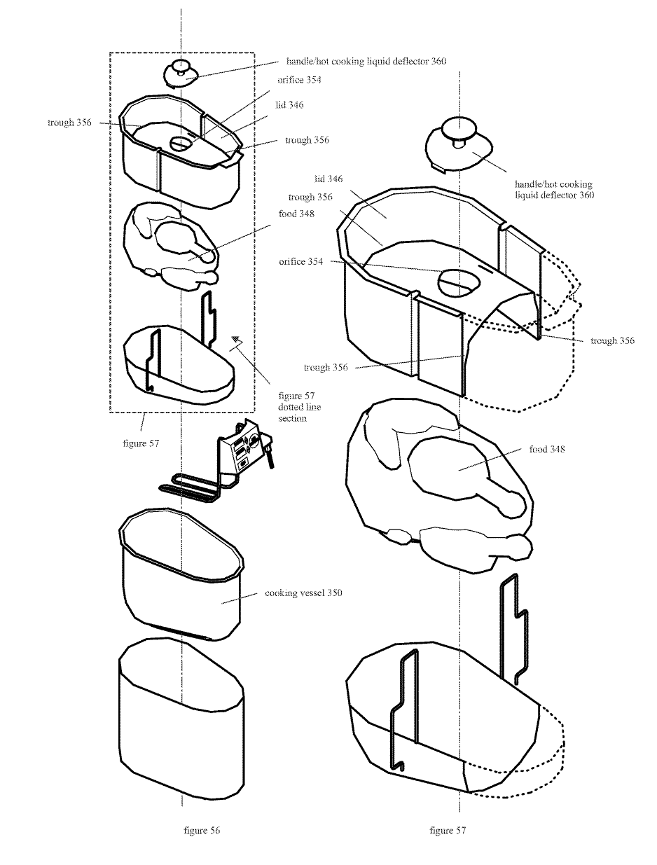

Food mount 168, FIGS. 10 through 15:

Food mount 168 is generally comprised of: food support 170, first food support handle 172, second food support handle 174, cooking device 176 (shown as a deep fryer, as a non-limiting and non-exhaustive example), cooking device lid 178, and food lock 180.

As a non-limiting and non-exhaustive example of how food mount 168 might be used, food 182 (shown as a fowl) is placed into food support 170 (shown as a wire screen basket in FIG. 10) and, using slots 179 and 181, lid 178 is slidably engaged onto the rod-like interior portions of both first food support handle 172, and second food support handle 174, and the bottom portion of cooking device lid 178 rests on the upper portion of food 182, and the entire assembly is mounted to cooking device 176, as shown in FIG. 11.

Before or after such mounting, food 182 is straightened, and food lock 180 is inserted through holes 184 and 186 in lid 178, and it impales food 182, thus firmly locating food 182. Holes 184 and 186 allow free up-and-down movement of food lock 180 while solidly aligning it in a generally vertical disposition.

Firmly located food 182 may then be placed into any of a variety of cooking/food preparation environments, including, as non-limiting and non-exhaustive examples, in bake ovens, convection ovens, food boilers, deep fat fryers, microwaves, radiant heat ovens, freezers, refrigerators, slow cookers, sous vide, etc. FIGS. 10 through 15 illustrate firmly located food 182 being placed in a deep fryer.

Food mount 168, as with other food mounts shown herein, including in specific, food mounts 100, 130, 140, 188, 196, 206 and 230, may be easily adapted to numerous devices, including, but not limited to, example embodiments 268, 300, 308, 344, 364, and 498 shown herein.

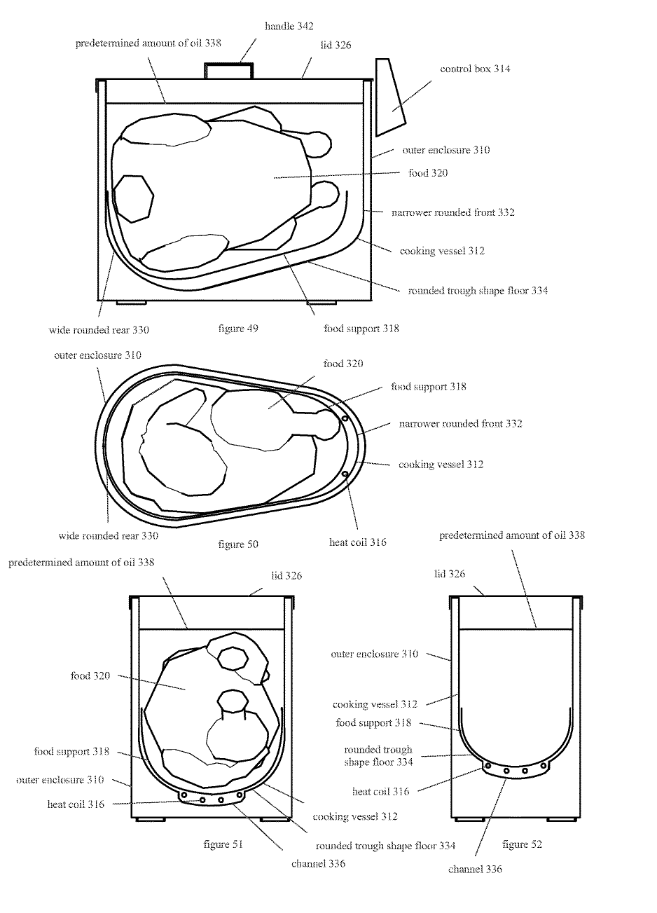

As a further non-limiting and non-exhaustive example, FIGS. 10 through 12 illustrate food mount 168 locating food 182, illustrated as a fowl, with its breast mounted downward into food support 170. To show device versatility, FIGS. 13 through 15 illustrate food mount 168 locating food 182 (a fowl), with its breast mounted upward.

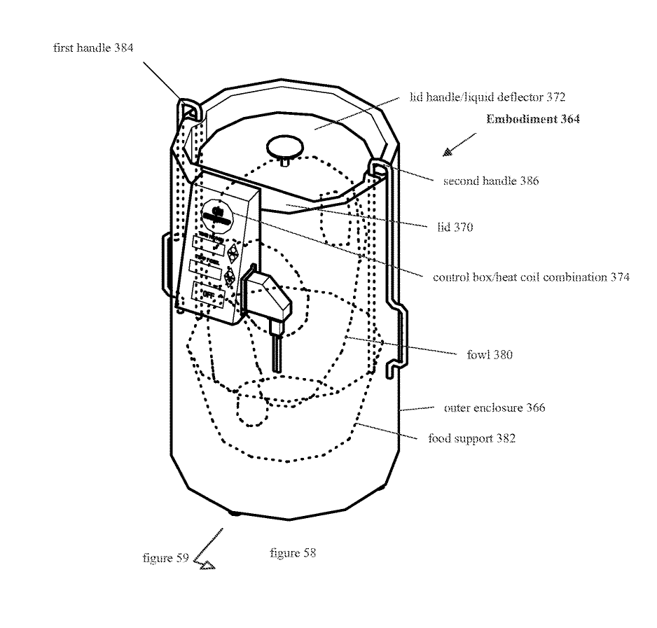

Food mount 188, FIG. 16:

FIG. 16 illustrates food mount 188, which shares most construction details with food mount 168, except instead of having U-shaped food lock 180 penetrating through two holes 184 186 in lid 178 to penetrate and secure food, food mount 188 uses one or more single rod skewers individually penetrating into food 192, each after passing through one of a plurality of holes 190 which pass through the central portion of lid 194.

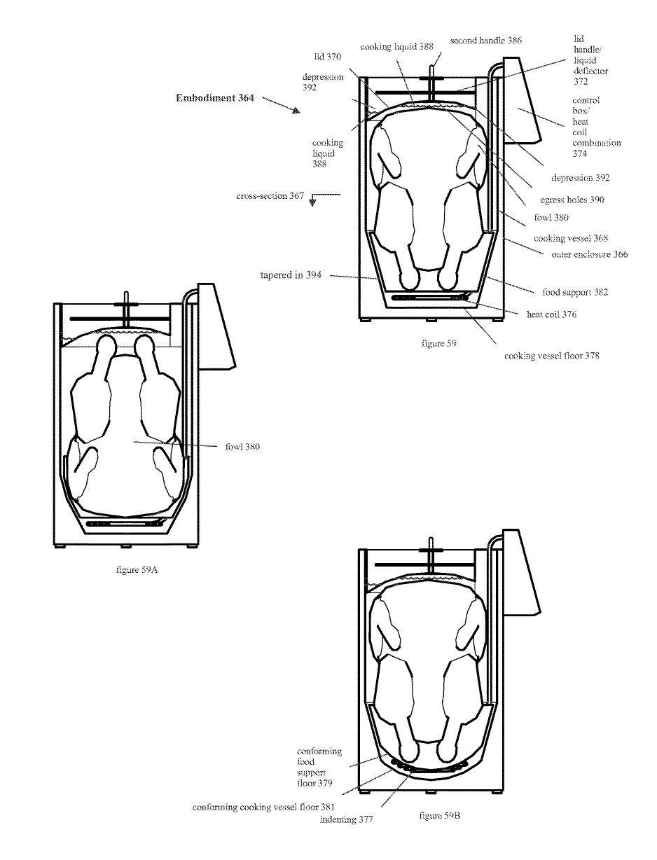

Food mount 196, FIG. 17:

Food mount 196, is comprised of essentially vertical open screen side wall food support 198, and one or more penetrating side skewers 200 and 202, which penetrate through open screen food support 198 walls, and lodge into food 204, thus stabilizing food 204 within food support 198.

As both a non-limiting and non-exhaustive example, food support 198's essentially vertical open screen side walls, might be constructed of quarter-inch mesh metal screening which allows penetrating side skewers 200 and 202 to easily pass through, and engage into food 204.

Again, such a food mounting system might be easily adapted to a variety of cooking/food preparation environments, such as have already been suggested for earlier example embodiments.

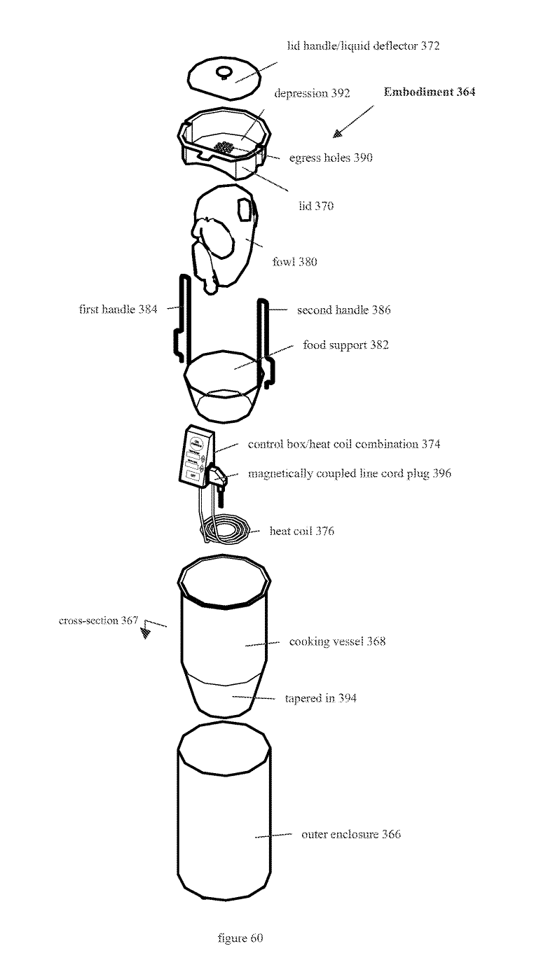

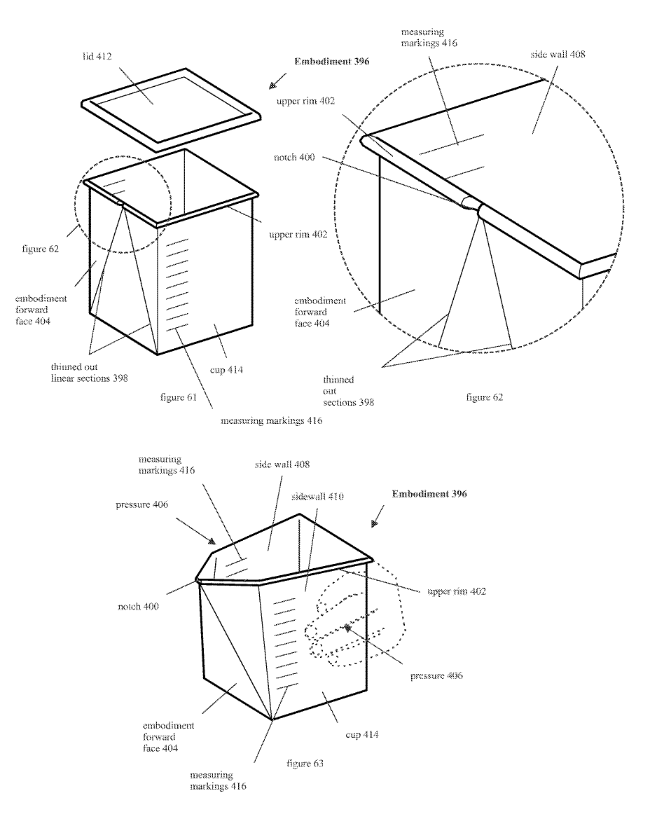

Food mount 206, FIGS. 18, 19, and 20:

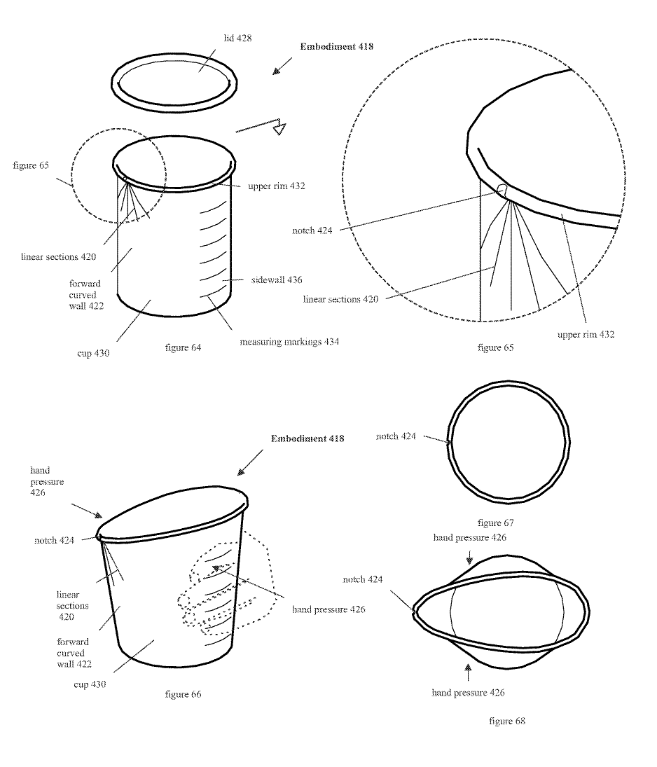

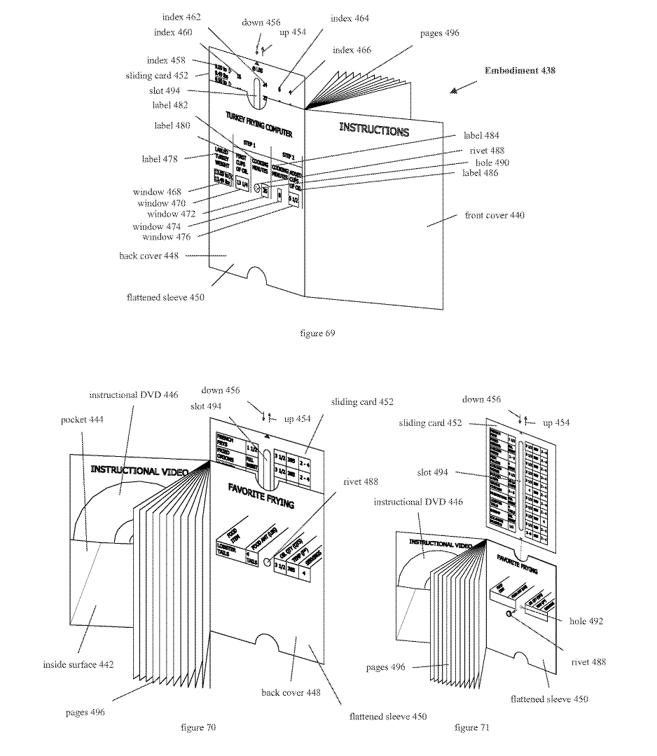

Food mount 206 is a unitary food mount constructed from bent resilient rod. When food 208 is lowered into food mount 206, downward gravitational pressure 210 is created on the central portion of food mount 206, which deflects the central portion downward 210 and causes both left 212 and right 214 gripping members to resiliently move inward 216 and grip and position food 208 (FIGS. 19 and 20).

FIGS. 19 and 20 illustrate how food mount 206 holding food 208, shown as a fowl, might be placed in a food support basket 218, with the fowl being positioned with either its breast up (FIG. 19) or its breast down (FIG. 20).

The upper horizontal portions 220 and 222 of both left gripping member 212 and right gripping member 214 may advantageously be used as hand gripping elements to lift and maneuver food mount 206 when it is mounting food 208.

Food mount 206 may also be used advantageously to mount food independently of a food support basket 218, and it may be used in a variety of cooking/food preparation environments as has already been detailed for example embodiments above. Example embodiment 220, FIGS. 21 through 25:

FIGS. 21 to 25 portray food support example embodiment 220 which is generally comprised of: food support 223, first food support handle 224,

Second food support handle 226, food cooker 228 (as non-limiting and non-exhaustive example, shown as a deep fryer), food positioning fork 230, and optionally, lid 232.

In use, food 234 (shown as a fowl) is placed into food support 223, and the combination is placed into food cooker 228 (especially FIG. 24). Before or after this placement, food 234 is properly positioned, food positioning fork 230 is impaled into one end of food 234 and snapped between and onto the inner segments of first food support handle 224 and second food support handle 226 as shown in FIGS. 21 through 23. Alternatively, fork 230 may be snapped on to the handle support members first and then slidably moved down 236, until fork 230 penetrates into, and fixedly locks into said proper position, food 234 (FIGS. 21, 22, 22A, and 22 especially).

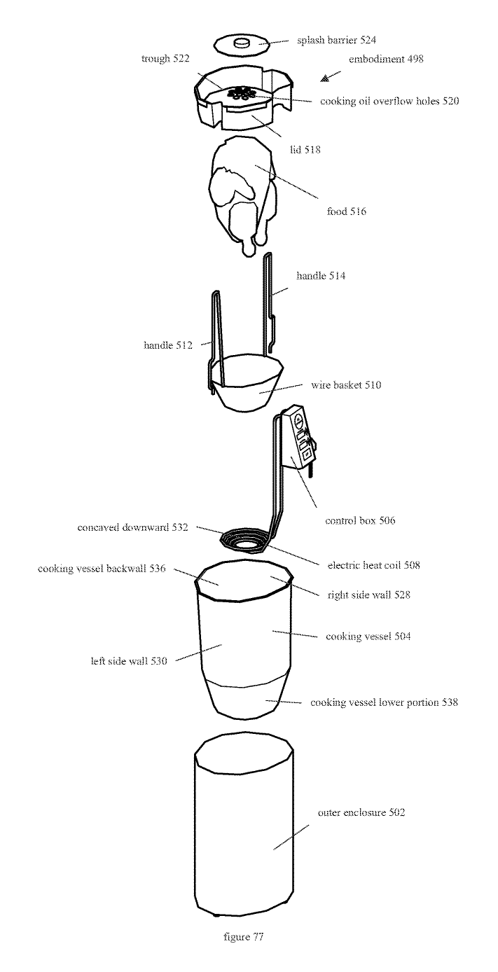

FIGS. 21 and 23, as a non-limiting and non-exhaustive example, illustrate the versatility of example embodiment 220 by showing food 234, portrayed as a fowl, with its breast down in FIG. 21, and its breast up in FIG. 23. Many other positions with many other foods are obviously possible.

Once again, example embodiment 220 is adaptable to many fields of application, including those already listed for earlier example embodiment 238, FIGS. 26, 27, and 28.

Example embodiment 238 is a cooking fluid filtering device, as a non-limiting and non-exhaustive example, which may filter frying oil in a deep fryer. It is generally comprised of: food support 240, cooking chamber 242, and fluid filter 244.

In use, as a non-limiting and non-exhaustive example, fluid filter 244 is placed into the bottom of cooking chamber 242, as shown in FIG. 27. Cooking fluid is then poured into cooking chamber 242 and food 246 is placed into food support 240 lowered into cooking chamber 242, finally resting above fluid filter 244, as shown in FIGS. 26 and 27.

At any time during or after the cooking of food 246 within cooking chamber 242, food support 240 as well as contained food 246, may be removed and fluid filter 244 lifted upward, causing the cooking fluid contained within a cooking chamber 242 to pass through lower filtering portion 246 of filter 244, thus straining pollutants from the cooking fluid.

Flip up handle 248, firmly snaps into its raised lifting position, as shown in FIG. 28, and may help in removal and insertion of fluid filter 244. Before lowering food into cooking chamber 242, flip up handle 248 is configured to be able to snap back to its lower storage position, as shown by dotted lines in FIG. 28. Example embodiment 238 provides a simple, easy way to filter cooking fluids.

Example embodiment 250, FIGS. 29 through 31:

Example embodiment 250 illustrates a simplified method of accurately measuring cooking fluid.

FIG. 29 shows food 252, resting within food support 254, being lowered 256 into cooking liquid 258. In FIG. 29, only an approximate amount of cooking liquid has been added. This amount should be at, or it should slightly exceed the amount of cooking liquid needed for the upcoming cooking operation.

Cooking vessel 260 has overflow holes 262, which channel cooking liquid which overflows from cooking vessel 260, into overflow containment reservoir 264, where the cooking liquid is saved and can be later recycled or disposed of Overflow containment reservoir 264 is formed in the space between outer enclosure 266 and cooking vessel 260. If for any reason, too much cooking liquid was added, the excess cooking liquid overflows through overflow holes 262, and is safely stored in overflow containment reservoir 264.

This method of allowing excess cooking liquid to overflow into an overflow containment reservoir may provide a simple and accurate method of measuring cooking liquid.

FIGS. 30 and 31 show a non-limiting and non-exhaustive example of how this method might be applied to a multistage cooking operation, where only a portion of a food is cooked at any one time.

FIG. 30 shows food 252, a fowl, being immersed into cooking liquid 258 in a feet down position, and overflow holes 262 accepting overflowing cooking liquid and channeling it into overflow containment reservoir 264.

FIG. 31 shows a subsequent operation where food 252 has been inverted to now be breast down, displacing a greater volume of cooking liquid than when food 252 was feet down. This greater volume displacement of food 252 may cause additional cooking liquid overflow into overflow containment reservoir 264.

In both FIGS. 30 and 31 examples, accurate cooking liquid measurement is achieved by allowing excess cooking liquid to overflow into overflow containment reservoir 264. This method may be adaptable to many settings, including environments suggested for previous example embodiments. As a non-limiting and non-exhaustive example, it may be used for deep frying as illustrated.

Example embodiment 268, FIGS. 32 through 45:

Example embodiment 268 is comprised of: outer enclosure 270, cooking vessel 272, control box 276, food support 274, and optionally, lid 277.

Cooking vessel 272 is formed as shown in FIGS. 39 through 43, with rounded broad rear 280 tapering front-to-back to rounded narrower front 282. Cooking vessel 272 is elongated, having a maximum horizontal length at least 110% bigger than its maximum horizontal width.

Measured one quarter of the length in from either end, cooking vessel 272 may have no taper or be tapered up to being 30% wider at one end than at its opposite end.

Control box 276 is firmly coupled to heat coil 286. This assemblage removably mounts and dismounts directly to and from cooking vessel 272.

As a non-limiting and non-exhaustive example of use, cooking vessel 272 is placed within outer enclosure 270 in one of three positions, as illustrated in FIGS. 32, 33, and 34 (also in FIGS. 35 through 38).

In the first position, FIGS. 32 and 35, rounded floor 278 of cooking vessel 272 is inclined rearward at generally 15 degrees, to lower rounded broad rear 280 below rounded narrower front 282. Depending on the size and form of the article of food being cooked, including, but not limited to, the size and body form of fowl, advantageous rearward inclinations of between 5 and 45° have been found.

An appropriate amount of cooking liquid 283 for large contained food 284 being fully immersed into the lowered rounded broad rear of cooking vessel 272, is added into cooking vessel 272 and heated to cooking temperatures. Food support 274 with large contained food 284 is then lowered into cooking vessel 272, as shown in FIG. 32.

When in this first position (FIGS. 32, 35), large food items, including those that taper, such fowls in general, can be both accommodated and cooked using a highly efficient amount of cooking liquid. The lowered rounded broad rear 280 is configured to accept the large food item, and the rearward inclination helps fully immerse the tapered item efficiently, as shown in FIGS. 32 and 35. This minimizes the amount of cooking liquid needed to cook such large tapered food items, including, but not limited to, a Thanksgiving Day size turkey.

In the third of the three positions, as shown in FIGS. 34 and 38, rounded floor 278 is inclined forward generally 20°-plus or minus 15°. The narrowness of rounded front 282 combined with the forward inclination of rounded floor 278, means that only a very efficient, and relatively small amount of cooking liquid 294 needs be used in cooking a small tapered food, such as in general, smaller fowl 288.

In the second of the three positions, as shown in FIGS. 33, 36 and 37, rounded floor 278 is generally horizontal. As shown in FIG. 37, larger foods, including larger tapered foods such as fowl 290 shown, and including, but not limited to, a Thanksgiving Day sized turkey, can be cooked in this second position, but cooking liquid 292 usage when cooking such foods is not as minimized as when using the first position to cook similar foods.

Each of the three positions can be made into a dedicated device, with a cooking vessel which lacks the ability to move between one or more alternate positions.

Lid 277 is optional, and may contribute safety as well as other features.

As shown most clearly in FIG. 45, magnetically coupled power cord 296 connects directly into the right side of control box 276.

Example embodiment 300, FIG. 46:

FIGS. 32, 35, and 37 show large foods, exemplified by large fowls 284, and 290, being cooked in cooking vessel 272, which is dimensioned to accept fowls when they are resting on their sides. FIG. 46 demonstrates that example embodiments, such as example embodiment 300, are possible which are dimensioned to allow large fowls, such as large fowl 298, to be accommodated while such fowls 298 are resting breast down, or on their back, and yet such example embodiments may achieve high cooking liquid use efficiency.

Example embodiment 302, FIG. 47:

Example embodiment 302 utilizes one or more objects 305 (exemplified by sealed metal can 305) placed inside the cavity of a fowl being cooked in liquid, in order to reduce the amount of cooking liquid required. In FIG. 47, sealed metal can 304 is shown just prior to it being inserted 304 into the empty cavity of fowl 306. Such objects 305 may be formed to have bullet shaped insertion ends to facilitate placement.

One or more objects may be placed inside the cavity of a fowl being cooked in liquid, including, but not limited to a fowl being deep fried in oil. Such objects may include: sealed cans, marbles, sealed bottles, stones, paper, wood, gravel, rubber, plastic, ceramic, glass, metal, and hollow or solid objects of compatible materials, with various suitable shapes and sizes.

Advantageously, such object or objects should displace at least 20% of the volume inside the gut cavity of a fowl being cooked.

Advantageously, such object or objects should not chemically or otherwise interact with either cooking liquid or food being cooked.

Also, such object or objects should not degrade in cooking liquid at normal cooking temperatures.

Example embodiment 308, FIGS. 48 through 53:

Example embodiment 308 is a device to cook articles in liquid, and more specifically, although not limited to, a device configured to deep fry fowl in oil. Example embodiment 308 comprises: outer enclosure 310, which removably couples cooking vessel 312, which in turn is rigidly and removably connected to control box 314, which in turn fixedly attaches heat coil 316. Food support 318 is configured to mount food 320 and, from time to time, and under user control, to be lowered into, and to be removed from, cooking vessel 312.

Food support 318 includes first handle 322 and second handle 324. Lid 326, including pollutant filter 328, and handle 342, at user discretion, and under user control, may cover cooking vessel 312.

As shown most clearly in FIGS. 48 through 52, cooking vessel 312 is elongated with a maximum length which is at least 110% it's maximum width.

Cooking vessel 312 also has wide rounded rear 330 which tapers to narrower rounded front

332. Measured one quarter of the length in from either end, cooking vessel 312 may have no taper or be tapered up to being 30% wider at one end than at its opposite end. Independent of this, cooking vessel 312 also has rounded trough shaped floor 334 which, when measured from a low point one quarter the length of said cooking vessel in from a first end of said cooking vessel, to a low point one quarter the length of said cooking vessel in from a second end of said cooking vessel, is inclined downward front-to-back at 20° plus or minus 15°, with a general 15° inclination being particularly advantageous, at least for cooking oil conservation, for certain foods, including, but not limited to, many fowl, including in particular, but not limited to, a Thanksgiving day sized turkey.

Channel 336 is indented down from trough shape floor 334, and is configured to accommodate heat coil 316 in an oil usage efficient manner.

As both a non-limiting and non-exhaustive example, in use, a predetermined amount of oil 338 (FIG. 49) is poured into cooking vessel 312, and the oil is heated to cooking temperatures utilizing control box 314 and heat coil 316.

Food 320 is then placed into food support 318, and the food 320/food support 318 combination is lowered into cooking vessel 312, and is left there until cooking is complete, at which time it is removed from the cooking vessel, and served.

Also as non-limiting and non-exhaustive examples, outer enclosure 310 may be constructed from suitable painted or coated metal, or from appropriate plastic. Cooking vessel 312 might be constructed of drawn metal, such as anodized aluminum, or plated or nonstick coated steel. Food support 318 might be constructed from metal screening or perforated metal.

First handle 322 and second handle 324 might be constructed from coated or plated bent metal rod. Lid 326 might be constructed of appropriate plastic, and pollutant filter 328 might be made from die cut nonwoven polyester mesh coated with activated charcoal, and/or it might be a perforated metal condensation filter, similar to many commercial cooking vents.

Handle 342 is centrally disposed on the upper surface of lid 326 and helps in placing and removing lid 326 on and from cooking vessel 312.

Line cord plug 340, as shown most clearly in FIG. 48, is a magnetically coupled plug which connects directly into the right side of control box 314.

As with other example embodiments shown herein, use of the term “cooking in cooking liquid”, or similar such statements herein, may include, but is not necessarily limited to, deep frying in oil.

Example embodiment 344, FIGS. 54 through 57:

FIGS. 54 through 57 depict example embodiment 344, which is similar to example embodiment 308, except lid 326 is substituted by lid 346. Lid 346 helps reduce cooking liquid usage by more closely containing food 348.

As shown most clearly in FIG. 55, cooking liquid within cooking vessel 350 may rise to level 352, at which time it may overflow through orifice 354 into trough 356, which is disposed around the lower perimeter of lid 346. Before this happens, cooking liquid rising above floor 358 of trough 356 is displaced by air within trough 356 until cooking liquid reaches the lower edge of orifice 354, at which time it overflows 362 into trough 356.

Lid 346 thus helps reduce the amount of cooking liquid used by using air to displace the cooking liquid, and lid 346 helps provide overflow protection by supplying a reservoir for cooking liquid excess.

User removable handle/hot cooking liquid deflector 360 helps safely deflect any liquid exiting through orifice 354 away from users, and it provides a hand hold for lid 346.

Example embodiment 364, FIGS. 58 through 60:

Example embodiment 364 is configured to cook elongated unitary foods by placing such foods with a generally vertical longitudinal axis disposition.

Referring to FIG. 59, example embodiment 364 generally comprises: outer enclosure 366 which removably and internally mounts cooking vessel 368, which, from time-to-time, and at user discretion, mounts lid 370, including attached removable lid handle/liquid deflector 372. Outer enclosure 366 also removably mounts control box/heat coil combination 374. Food support 382, from time-to-time, is configured to hold food being cooked, such as fowl 380, and may while doing so, and using attached first handle 384 and second handle 386, be lowered into hot cooking liquid held within cooking vessel 368.

Referring to FIGS. 1 through 25, any of the food positioning/holding mechanisms shown, might be adapted for use with example embodiment 364.

Cooking vessel 368, as non-limiting and non-exhaustive examples, may have a generally: circular, elliptical, rounded square, irregular, asymmetric, or rounded diamond shaped cross-section 367.

Heat coil 376 is spiral and electrically energized. As shown in FIG. 59, it is generally positioned with its flat upper surface horizontally disposed. Heat coil 376 is disposed over cooking vessel floor 378, which is also generally horizontal and flat.

As shown in FIG. 59A, variants of the example embodiment shown in FIG. 59 include altering the dimensions and form of food support 382 and cooking vessel 368 (and possibly heat coil 376, as shown in FIG. 59B) to also efficiently accommodate a fowl in a breast down disposition.

As both a non-limiting and non-exhaustive example, the example embodiment shown in FIG. 59, in order to deep fry a Thanksgiving day sized turkey (generally 15 pounds plus or minus 5 pounds product tag weight), while reducing the oil required, would be to dimension cooking vessel 368 to be between 8 and 12 inches in diameter, with it being particularly advantageous at between 8½ and 10 inches in diameter. Fowl 380 could be held in position utilizing food mounts shown earlier, including in particular, but not limited to, food mounts 168, 188, 196, 206, and 230.

As shown in FIG. 59B, variants of this configuration may include indenting 377 the middle portion of heat coil 376's spiral down with a downward generally concave conical or partial ellipsoidal cross-section, and conforming food support floor 379, and also conforming cooking vessel floor 381, to each have a generally parallel cross-section. Such variants inherently might better fit certain foods, such as fowl 380 shown, and thus conserve cooking liquid.

As a non-limiting and non-exhaustive example, in use, cooking vessel 368 is filled with a predetermined amount of cooking liquid 388 which is then heated to cooking temperatures, using control box/heat coil combination 374. Food, represented by fowl 380, is then loaded into food support 382, and combination is then lowered into cooking vessel 368. Lid 370 is then lowered into place.

Should cooking liquid exceed what is needed, overflow is directed through egress holes 390, which output the overflow into depression 392, which is at the bottom of lid 370 and is proximate to egress holes 390.

Lid handle/liquid deflector 372 acts as a lid handle and also prevents any liquid leaving through egress holes 390 from directly splashing onto users. Lid handle/liquid deflector 372 is removable for cleaning or other purposes. As a non-limiting and non-exhaustive example, it might be attached with a hand activated snap fit or a wingnut.

Once cooking is complete, using first handle 384 and second handle 386, food support 382, including supported food, fowl 380, is raised out of cooking vessel 368, and the food may be served.

With little or no modification, example embodiment 364 might be used to cook foods in two or more stages, such as cooking only a portion of such foods in any single stage.

Cooking vessel 368 is tapered in 394 along is lower portion. Such tapering helps better conform to some foods, such as fowl 380 shown, and thus such tapering may help conserve cooking liquid. Tapering 394 in FIGS. 59, 59A and 59B includes curving and tapering, as shown in FIG. 59A.

Magnetically coupled line cord plug 396 attaches directly into the right side of the control box (FIG. 60).

Food support 382 may have a removable lid to contain and/or submerge various foods below cooking liquid.

Example embodiment 396, FIGS. 61 through 63:

Example embodiment 396 may be used to at least measure, store, and pour cooking liquids or other dry or liquid pourable materials. As non-limiting and non-exhaustive examples, example embodiment 396 may be fabricated from a pliable material, including, but not limited to: polyethylene, polypropylene, silicone rubber, neoprene rubber, or nylon.

Thinned out linear sections 398 in example embodiment forward face 404, provide living hinge flexing regions. These in combination with notch

400 in upper rim 402, as well as optionally molding example embodiment 396 in a slightly open pouring position, as shown in FIG. 63, bias forward face 404 outward so that when hand pressure 406 is simultaneously applied to side wall 408 and sidewall 410, a pour spout is formed, FIG. 63.

Sealing example embodiment 396 fluid tight when lid 412 caps cup 414, is done on the inside of upper rim 402, including behind notch 400, thus ensuring a complete fluid tight seal after lid 412 is in place capping cup 414.

Measuring markings 416 in sidewall 408 and sidewall 410 allow example embodiment 396 to be used as a measuring cup.

Example embodiment 418, FIGS. 64 through 68:

Example embodiment 418, like example embodiment 396, may be used to at least measure, store, and pour cooking liquids or other liquid or dry materials. Also, as a non-limiting and non-exhaustive example, example embodiment 418 may be fabricated from a pliable material, including, but not limited to: polyethylene, polypropylene, silicone rubber, neoprene rubber, or nylon.

And, thinned out linear sections 420 in example embodiment forward curved wall 422, provide living hinge flexing regions. These, in combination with notch 424, cause forward curved wall 422 to bulge outward into a pouring spout, under hand pressure 426, as shown in FIGS. 66 and 68.

Also, sealing example embodiment 418 fluid tight when lid 428 caps cup 430, is done on the inside of upper rim 432, including behind notch 424, thus ensuring a complete fluid tight seal after lid 428 is in place capping cup 430.

Measuring markings 434 in sidewall 436 allow example embodiment 418 to be used as a measuring cup. Example embodiment 438, FIGS. 69, 70, and 71. Example embodiment 438 is an instructional device, with specific application to household cooking appliances. Example embodiment 438 generally comprises: front cover 440, which has on inside surface 442, pocket 444, which holds instructional DVD 446 (and/or similar data storage devices, such as, as non-limiting and non-exhaustive examples, SD card, memory stick, thumb drive, etc.). Example embodiment 438 also comprises: back cover 448, which is formed into a flattened sleeve 450 mounting sliding card 452, which, under user guidance, moves up 454 and down 456 within flattened sleeve 450.

Indices 458, 460, 462, 464, and 466 may be registered in windows 468, 470, 472, 474, and 476 respectively, by moving slighting card 452 up 454 and down 456. Windows 468, 470, 472, 474, and 476 are disposed near the vertical center of back cover 448, and they allow selective viewing of indices 458, 460, 462, 464, and 466 on sliding card 452, which is located within flattened sleeve 450, and directly behind back cover 448.

Labels 478, 480, 482, 484, and 486 identify the meaning of indices 458, 460, 462, 464, and 466 that are viewed through windows 468, 470, 472, 474, and 476 respectively.

As a non-limiting and non-exhaustive example, when deep frying a turkey using a certain two-step cooking method, where a first part of the turkey is fried in hot oil, and then the turkey is repositioned, oil is added, and a second part of the turkey is fried in hot oil, a user may need to know, based on the turkey weight, how much oil, and how much time is needed for the first step, and how much oil, and how much time is needed for the second step.

So, to continue the example, assume a user wishes to cook a 13.3 pound turkey. The user moves sliding card 452 up 454 and down 456 until the proper labeled turkey weight, in this case “13.00 to 13.49 lbs”, is displayed in window 468 (FIG. 69). When this occurs, windows 470 and 472 display respectively, the initial number of cups of oil (13¼), and the number of minutes (35) needed for the first cooking step, labeled “STEP 1” above labels 480 and 482; and windows 474 and 476 respectively display the cooking minutes (8) and added cups of oil (5½) needed for the second cooking step, labeled “STEP 2” above labels 484 and 486.

As a variant of this design, fewer or more windows may be used, depending on specific needs. As a non-limiting and non-exhaustive example, if example embodiment 438 were used in connection with cooking an article of food in a more conventional one step deep fry, only windows 468, 470 and 472 might be used. Windows 474 and 476 might be eliminated.

Referring to FIGS. 70 and 71, on the inside of back cover 448, the backside of sliding card 452 uses the same method as the front side of sliding card 452, to provide various deep frying information for specific food items, including: the food amount to be cooked, the quantity of oil needed, the temperature at which frying will occur, and the number of servings that will be provided.

Rivet 488 penetrates through hole 490, slot 494 and hole 492 to prevent sliding card 452 from falling out of flattened sleeve 450.

Alternatively, rivet 488 may not be present, and multiple cards, providing multiple pieces of information front and/or back, could be placed inside of flattened sleeve 450.

Pages 496 may be used for any purpose. As non-limiting and non-exhaustive examples, they might be used for: recipes, device instructions, safety warnings, illustrations, device specifications, contact information, and/or other things.

Example embodiment 498, FIGS. 72, 73, 74, and 75:

Example embodiment 498 is a deep fryer that is specifically adapted for cooking fowl, including Thanksgiving day turkeys, using minimal amounts of oil. It also may be used for frying most other fry-able foods.

Example embodiment 498 generally comprises: outer enclosure 502, which removably and internally mounts cooking vessel 504, which in turn removably mounts control box 506, which in turn rigidly mounts electric heat coil 508, which is of spiral configuration, and is disposed inside of cooking vessel 504 during cooking operations.

Also during cooking operations, wire basket 510, mounting food 516, may be lowered into cooking vessel 504, as shown in FIG. 75. Wire basket 510 is rigidly coupled to handles 512 and 514 and rests proximate to and above electric heat coil 508 as shown especially in FIG. 75.

Lid 518 has cooking oil overflow holes 520, which allow excess oil reaching the overflow holes to exit into trough 522, disposed on the periphery of lid 518, as shown especially in FIGS. 72 and 75. Trough 522 serves as a reservoir for containing exiting excess oil.

Splash barrier 524 is rigidly and removably mounted to lid 518, and helps prevent example embodiment users from getting accidentally splashed with hot cooking oil exiting through overflow holes 520.

Lid handle 526 protrudes from the upper surface of splash barrier 524, and facilitates the lifting and removing of lid 518 from the upper portion of cooking vessel 504.

From halfway up the height of cooking vessel 504, right side wall 528 of cooking vessel 504 has a generally vertical disposition, and left side wall 530 is diagonally tilted at between 5° and 40° off vertical, as shown in FIG. 75. This facilitates efficient use of cooking oil when cooking a typical fowl.

Electric heat coil 508 is concaved downward 533, with its center being lower than its periphery. This is paralleled by the concave floors of wire basket 510 and cooking vessel 504 (see especially FIG. 75). This also promotes efficient cooking oil usage when cooking a typical fowl.

To further promote the efficient use of cooking oil, cooking vessel lower portion 538 may be tapered in on both or one of its sides as well as on its front and/or its back, as shown in FIGS. 75 and 77 especially.

FIG. 76 shows variant example embodiment 532, which shares construction and form details with example embodiment 498, except that it is dimensioned and configured to hold a fowl with its breast and/or its back facing left cooking vessel side wall 534. By contrast, example embodiment 498 is dimensioned and configured to hold a fowl with its breast and/or back facing cooking vessel back wall 536 (FIGS. 75 and 76 especially).

In-use operations of example embodiments 498 and 532 are similar to the in-use operation described earlier herein for example embodiment 364.

What is claimed is:

1. An apparatus to support and position foods within food preparation apparatus comprising:
a vertically disposed food mounting rod;
a removable stop affixed to a first end of the food mounting rod and a stop affixed to a second end of the food mounting rod, wherein both stops are configured to prevent food, when transfixed by the rod, from sliding off their respective ends;
the first end configured to impale foods when the removable stop is not a fixed to the first end;
a support framework removably coupled at the first end to the vertically disposed rod, and while so coupled configured to suspend the second end within a thermostatically controlled food preparation environments contained within a food preparation chamber, wherein the support framework is further configured to removably couple to the second end, and while so coupled, to suspend the first end within a thermostatically controlled food preparation environment contained within a food preparation chamber.

2. The device of claim 1 wherein the vertically disposed rod is comprised of a plurality of generally parallel rod elements.

3. An apparatus to support and position foods within food preparation apparatus comprising:
a food support frame including a first food support rod and a second food support rod, the first food support rod having a first food piercing end and the second food support rod having a second food piercing end; wherein
the food support frame is resiliently mounted to the first food support rod and the second food support rod, such that flexing the support frame results in the first food piercing end being disposed at different distances from the second food piercing end;
the first food support rod is generally horizontal and coaxial with the second food support rod; and
the first food support rod and the second food support rod are configured to simultaneously and opposedly impale unitary articles of food, the food support frame configured to suspend the first food support rod and the second food support rod, along with any article of food impaled on the first food support rod and the second food support rod, within a thermostatically controlled food preparation environment contained within a food preparation chamber.

4. A device to support and position foods within food preparation apparatus comprising:
a liquid permeable food support vessel having a vertical handle support member affixed to and extending upward therefrom;
an open-topped cooking vessel configured to simultaneously contain cooking liquid and the liquid permeable food support vessel while being concurrently disposed within a thermostatically controlled food preparation environment contained inside of the open-topped cooking vessel;
a lid configured to selectively cover the open-topped cooking vessel, and while so disposed, being slidably coupled to the vertical handle support member for vertical movement;
a generally vertical food piercing rod slidingly engaged with the lid through an orifice penetrating the lid, and further configured while penetrating through the orifice, to impale food contained below the lid and which is simultaneously supported by the liquid permeable food support vessel.

5. A device to support and position foods within food preparation apparatus comprising:
an open-topped food support vessel having a generally horizontal floor with peripheral, generally vertical, upwardly projecting, perforated side walls;
a thermostatically controlled food preparation environment contained within an open-topped cooking vessel the food support selectively disposed within the thermostatically controlled food preparation environment within the open-topped cooking vessel; and
a first piercing rod member configured to penetrate the perforated side walls and lance food articles disposed within the food support vessel while concurrently engaging the perforated side walls.

6. A device to support and position foods within food preparation apparatus comprising:
an upward thrusting, right-hand food gripping member and an upward thrusting, left-hand food gripping member, each gripping member rigidly coupled at their base to opposite ends of an upward arching, resilient central portion, wherein this combined structure is configured to move upper portions of both the right-hand food gripping member and the left-hand food gripping member converging toward one other when a food article to be supported by the device exerts downward gravitational pressure on the central portion of the upward arching resilient central portion, and through such converging, both of the food gripping members engaging opposed sides of a food article supported by the device.

7. A device to support and position foods within food preparation apparatus comprising:
a food support having a floor and an upwardly disposed, generally vertical, handle support rod;
a thermostatically controlled food preparation environment contained within an open-topped food preparation chamber;
a generally vertical food engagement spike rigidly engaged to a coupling, the coupling under user control, being configured to releasably and slidably engage the vertical handle support rod to support and position unitary food articles between the floor on a low side and the spike on a high side.

8. The device of claim 7 further comprising the vertical handle support rod comprised of a plurality of generally parallel rod members.

9. The device of claim 7 further comprising the spike being comprised of a plurality of generally parallel spike members.

10. A device to filter cooking liquids, comprising:
an open-topped cooking vessel, having a generally horizontal floor with side walls projecting upward from the periphery of the floor, and the open-topped cooking vessel configured to contain cooking liquid a heating source configured to heat to cooking temperatures cooking liquids contained within the cooking vessel,
generally horizontal and flat filter, configured to rest, from time to time, within the cooking vessel proximate to its bottom, and while so disposed, the generally horizontal and flat filter configured to generally horizontally, and contiguously span the interior side walls of the cooking vessel; and
while cooking liquid is contained within the cooking vessel, the generally horizontal and flat filter being configured to be hand lifted upward, and thereby gravitationally filter cooking liquid within the cooking vessel through the generally horizontal and flat filter.

11. A method of measuring cooking liquid in a food preparation device which has a cooking vessel configured to hold cooking liquid and the cooking vessel including an egress overflow spillway in its upper portion, to direct any excess cooking liquid within the cooking vessel, out of the cooking vessel comprising:
filling the cooking vessel with a predetermined amount of cooking liquid corresponding to specified cooking operation;
placing food to be cooked in the cooking operation into the cooking vessel filled with the predetermined amount of cooking liquid, such that any excess cooking liquid exits the cooking vessel through the overflow spillway; and
performing the specified cooking operation.

12. A device to cook articles of food, including fowl, comprising:
an elongated, open-topped cooking vessel having a floor and sidewalls extending generally vertically up from the periphery of the floor, and with a maximum horizontal length which is at least 110% its maximum horizontal width;
the open-topped cooking vessel configured to simultaneously hold both food and cooking liquid used to cook the food;
a heat source configured to heat both cooking liquid and food being cooked in the cooking liquid to cooking temperatures; and
a support frame configured to hold the elongated, open-topped cooking vessel with the cooking vessel floor being inclined at least 10° measured from a low point one quarter the length in from one end of the cooking vessel, to a second low point one quarter the length in from an opposite end of the elongated open-topped cooking vessel.

13. The device of claim 12, wherein the support frame is also configured to hold the elongated open-topped cooking vessel in a disposition such that the cooking vessel floor is disposed generally horizontal.

14. A device to reduce cooking oil usage when frying fowl, comprising a volume displacement object configured to rest within a gut cavity of a fowl while the fowl is being cooked in cooking oil, while displacing at least 20% of the volume inside the gut cavity of a foul being cooked, which would otherwise be filled with cooking oil.

15. The device of claim 14 wherein the volume displacement object is comprised of a plurality of displacements elements.

16. A device to cook fowl in cooking liquid, comprising:
an elongated, open-topped cooking vessel, including a floor with a generally vertical annular side wall around the periphery of the floor;
the elongated open-topped cooking vessel horizontal length is at least 15% greater than a maximum horizontal width of the vessel and wherein, when measured one quarter length in from each end, the floor at its lowest points being vertically inclined at least 5°, the elongated open-topped cooking vessel is configured to simultaneously hold cooking liquid and food being cooked in the cooking liquid; and
a heat source, configured to heat to cooking temperatures, cooking liquid and food being cooked in the cooking liquid, while they are both concurrently disposed within the elongated open-topped cooking vessel.

17. The device of claim 16, further comprising:
a lid configured to selectively cover the elongated, open-topped cooking vessel;
the lid having a raised central portion penetrated by an egress hole proximate to its apex; and
the center portion having a trough configured to hold liquid, and the trough disposed proximate to the periphery of the center portion, wherein the trough is further configured to accept and hold liquid leaving the egress holes.

18. A device to protect users from overflowing hot cooking liquid, comprising:
a cooking vessel configured to simultaneously hold hot cooking liquid and food being cooked in the hot cooking liquid;
a heat source configured to heat, to cooking temperatures, cooking liquid and food being cooked in the cooking liquid, while such liquid and food are disposed within the cooking vessel;
a lid configured to selectively cover the cooking vessel, the lid having a raised central portion with an egress hole penetrating the raised central portion proximate to its apex;
the raised central portion having a trough, configured to hold liquid, proximate to the periphery of the raised central portion; and
wherein the trough is further configured to accept and hold cooking liquid overflowing out of the egress hole.

19. The device of claim 18, further including a deflection shield disposed above the egress hole, and the deflection shield generally blocking liquid exiting the egress holes, from directly splattering onto device users.

20. A device to cook fowl utilizing a reduced amount of cooking oil comprising:
an open-topped cooking vessel configured to hold cooking oil and food being cooked in the cooking oil;
the open-topped cooking vessel having a floor and upward and outward thrusting annular sidewalls projecting from the periphery of the floor, wherein the upward and outward thrusting sidewalls, at their upward periphery, transition to generally vertical annular sidewalls;
an electrically energized rod heat source formed into an inwardly spiraling, multi-spiral heat coil at a source disposed on the electrically energized rod heat source's lower end; wherein
the inwardly spiraling multi-spiral heat coil is disposed proximate to and above the floor.

21. The device of claim 20, further including a lid, and the lid selectively covering the cooking vessel and including a raised central portion with an egress hole penetrating the raised central portion proximate to the central portion's apex;
the raised central portion including a liquid containing trough proximate to its periphery; and
the trough configured to accept and hold cooking liquid overflowing the cooking vessel out of the egress hole.

22. A device to measure, store, and pour, liquid and dry pourable materials, comprising:
a vessel configured to hold pourable materials;
the vessel having a floor with peripheral, upward projecting, sheet-like, annular and generally vertical sidewalls formed from pliable material;
an outward thrusting weakened portion of the upper rim of the vessel, the weakened portion of the upper rim of the vessel configured to further project outward and away from the central vertical axis of the vessel when opposing inward manual pressure is exerted proximate to the upper rim of the vessel, adjacent to the weakened portion of the upper rim of the vessel.

23. An instructional device comprising:
a book;
a flattened sleeve coupled to the spine of the book;
an indices imprinted card disposed within the flattened sleeve, and the card configured to longitudinally move within the flattened sleeve;
the flattened sleeve having a see-through window exposing different indices on the indices imprinted card, through the see-through window; and
the indices exposed through the windows, being dependent on the disposition of the card within the flattened sleeve.

24. A device to cook fowl, utilizing a reduced amount of cooking oil, and the device comprising:
a cooking vessel, including a floor, and upward thrusting sidewalls emanating from the periphery of the floor, the cooking vessel configured to simultaneously hold cooking liquid and food being cooked in the cooking liquid;
a heat source configured to simultaneously heat, to cooking temperatures, cooking liquid and food being cooked in the cooking liquid within the cooking vessel; and
the upward thrusting sidewalls being annular, with generally vertical walls on a specific segment, and on a directly opposing segment, having walls inclined at an angle from between 5° and 40° outward off vertical.
